(19) United States
(12) Patent Application Publication
(10) Pub. No.: US 2025/0117308 A1
(43) Pub. Date: Apr. 10, 2025

(54) SYSTEMS AND METHODS FOR DETERMINING A COMPUTING SYSTEM’S CURRENT STATE BY IMPLEMENTING STATE MACHINES AND KNOWLEDGE GRAPHS IN AN ELECTRONIC ENVIRONMENT

(71) Applicant: BANK OF AMERICA CORPORATION, Charlotte, NC (US)

(72) Inventor: Maharaj Mukherjee, Poughkeepsie, NY (US)

(73) Assignee: BANK OF AMERICA CORPORATION, Charlotte, NC (US)

(21) Appl. No.: 18/376,556

(22) Filed: Oct. 4, 2023

(51) Int. Cl. G06F 11/34; G06F 9/451

(52) U.S. Cl. CPC G06F 11/3495; G06F 9/451

(57) ABSTRACT

Systems, computer program products, and methods are described herein for determining a computing system's current state by implementing state machines and knowledge graphs in an electronic environment. The present disclosure is configured to identify at least one knowledge graph comprising a plurality of clusters associated with at least one computing system, each cluster comprises a plurality of state machines associated with the at least one computing system; identify data associated with the computing system; apply the data associated with the computing system to at least one state machine; generate at least one output associated with the computing system; compare the at least one output with at least one pre-defined output; generate a confidence level for the at least one current state attribute; and determine a current state attribute for the computing system, wherein the current state attribute defines a current state of the computing system.

### TECHNOLOGICAL FIELD

Example embodiments of the present disclosure relate to systems and methods for determining a computing system's current state by implementing state machines and knowledge graphs in an electronic environment.

### BACKGROUND

It is very difficult to accurately and efficiently predict when computing systems may start performing poorly or not at all. This problem is exacerbated when considering how many components there are in each computing system, and how each of the components may interact with each other (e.g., by transmitting data, by relying on outputs of other components, by generating inputs for components, by sharing the same hardware and software, and/or the like). Thus, there exists a need for a system that can accurately, efficiently, and dynamically predict an overall computing system's health and performance, as well as each of its components, individually.

Applicant has identified a number of deficiencies and problems associated with determining a computing system's current state, including but not limited to potential computer system errors, failures, and processing speed difficulties. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for determining a computing system's current state by implementing state machines and knowledge graphs in an electronic environment.

In one aspect, a system for determining a computing system's current state by implementing state machines and knowledge graphs is provided. In some embodiments, the system may comprise: a memory device with computer-readable program code stored thereon; at least one processing device, wherein executing the computer-readable code is configured to cause the at least one processing device to perform the following operations: identify at least one knowledge graph comprising a plurality of clusters associated with at least one computing system, wherein each cluster of the plurality of clusters comprises a plurality of state machines associated with the at least one computing system; identify data associated with the at least one computing system; apply the data associated with the at least one computing system to at least one state machine of the plurality of state machines; generate, by the at least one state machine, at least one output associated with the at least one computing system; compare the at least one output with at least one pre-defined output, wherein the at least one pre-defined output is associated with at least one current state attribute of the at least one computing system; generate a confidence level for the at least one current state attribute based on a level of matching the at least one output to the at least one pre-defined output; and determine, based on the confidence level meeting a confidence level threshold, a current state attribute for the at least one computing system, wherein the current state attribute defines a current state of the at least one computing system.

In some embodiments, the application of the data is based on a computing component identifier of the at least one state machine. In some embodiments, the at least one output associated with the at least one computing system is associated with the computing component identifier.

In some embodiments, the at least one pre-defined output comprises a pre-defined pattern. In some embodiments, the confidence level is determined based on a likelihood of the at least one output to the at least one pre-defined output match. In some embodiments, the data associated with the at least one computing system is received by a state machine is based on at least one data subscription. In some embodiments, the at least one data subscription is associated with at least one state machine which transmits the data or at least one state machine which receives the data, and wherein the data subscription automatically causes a data transmission of the data to the at least one state machine which receives the data.

In some embodiments, the computer-readable code is configured to cause the at least one processing device to perform the following operations: generate a computing system alert interface component based on the current state attribute for the at least one computing system; and transmit the computing system alert interface component to a user device, wherein the computing system alert interface component configures a graphical user interface of the user device. In some embodiments, the computing system alert interface component is automatically transmitted to the user device and configures the graphical user interface of the user device in an instance where the current state attribute comprises a high alert.

In some embodiments, the computer-readable code is configured to cause the at least one processing device to perform the following operations: generate at least one heat map based on the at least one output for the at least one computing system, wherein the heat map comprises an indicator associated with the at least one current state attribute over a determined period; and generate a computing system heat map interface component based on the at least one heat map; and transmit the computing system heat map interface component to a user device, wherein the computing system heat map interface component configures a graphical user interface of the user device.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining a computing system's current state by implementing state machines and knowledge graphs in an electronic environment, in accordance with an embodiment of the disclosure;

FIG. 2 illustrates an exemplary machine learning (ML) subsystem architecture, in accordance with an embodiment of the disclosure;

FIG. 3 illustrates a process flow for determining a computing system's current state by implementing state machines and knowledge graphs in an electronic environment, in accordance with an embodiment of the disclosure;

FIG. 4 illustrates a process flow for generating and transmitting the computing system alert interface component to a user device, in accordance with an embodiment of the disclosure;

FIG. 5 illustrates a process flow for generating and transmitting a computing system heat map interface component, in accordance with an embodiment of the disclosure;

FIG. 6 illustrates an exemplary state machine, in accordance with an embodiment of the disclosure;

FIG. 7 illustrates an exemplary state machine with continuous pattern analysis comprising a plurality of state machines, in accordance with an embodiment of the disclosure;

FIG. 8 illustrates an exemplary cluster comprising a plurality of state machines, in accordance with an embodiment of the disclosure;

FIG. 9 illustrates an exemplary knowledge graph comprising a plurality of clusters, in accordance with an embodiment of the disclosure;

FIG. 10 illustrates an exemplary data flow for data subscriptions, in accordance with an embodiment of the disclosure;

FIG. 11 illustrates an exemplary computing system alert interface component comprising current states and immediately previous states for the computing system and its components which is used to determine the state of the computing system and its component(s), in accordance with an embodiment of the disclosure; and

FIG. 12 illustrates an exemplary computing system heat map interface component comprising current states and indicators for the computing system and its components, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

It is very difficult to accurately and efficiently predict when computing systems may start performing poorly or not at all. This problem is exacerbated when considering how many components there are in each computing system, and how each of the components may interact with each other (e.g., by transmitting data, by relying on outputs of other components, by generating inputs for components, by sharing the same hardware and software, and/or the like). Thus, there exists a need for a system that can accurately, efficiently, and dynamically predict an overall computing system's health and performance, as well as each of its components, individually.

Thus, the disclosure herein provides for a system, method, and apparatus which is designed and configured to solve each of these problems. For instance, the system is configured to create a knowledge graph comprising a plurality of clusters, whereby each cluster comprises a plurality of state machines and each state machine is associated with at least one computing system component. As the computing system components perform and interact, the state machines transition between states depending on the events for each component, whereby the system records each event and state transition and determines whether a pre-determined output or pattern has occurred that would indicate the current state of each of the components. Further, and as each of the components interact with each other or are supposed to interact with each other, the state machines and the clusters track the interactions, the state transitions, and the data transmissions for each of the interacting state machines and clusters. In this manner, the system can accurately track and portray the performance of not only the components individually, but of the components within the entire computing system overall and on a complex level. Similarly, and as the data of each component is tracked within each knowledge graph, cluster, and state machine, the system can determine—using those pre-defined outputs and patterns—whether the component is acting normally or poorly, or is likely to imminently start acting normally or poorly. In the instance where the component (or the entire computing system) is about to act poorly, the system may generate an alert to a user device associated with the computing system that intervention may be necessary, but without the undue delay of actually waiting for an error to occur to send such an alert. In this manner, the system may be proactive in its alert generation and mitigation efforts, rather than just reactive to computing system components errors.

Accordingly, the present disclosure provides for identifying at least one knowledge graph comprising a plurality of clusters associated with at least one computing system, wherein each cluster of the plurality of clusters comprises a plurality of state machines associated with the at least one computing system; identifying data associated with the at least one computing system; applying the data associated with the at least one computing system to at least one state machine of the plurality of state machines; and generating, by the at least one state machine, at least one output (e.g., at least one state) associated with the at least one computing system. The present disclosure further provides for comparing the at least one output with at least one pre-defined output (e.g., at least one pre-define state and/or a pattern of pre-defined states), wherein the at least one pre-defined output is associated with at least one current state attribute of the at least one computing system; generating a confidence level for the at least one current state attribute based on a level of matching the at least one output to the at least one pre-defined output; and determining, based on the confidence level meeting a confidence level threshold, a current state attribute (e.g., whether the computing system component is acting normal, or has a warning state, or is in an emergency state) for the at least one computing system, wherein the current state attribute defines a current state of the at least one computing system.

What is more, the present disclosure provides a technical solution to a technical problem. As described herein, the technical problem includes the determination of a computing system's current state. The technical solution presented herein allows for the accurate, efficient, and dynamic prediction of an overall computing system's health and performance, as well as the health and performance of each of its components, individually. In particular, the system is an improvement over existing solutions to the determination of the health and performance of computing systems (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

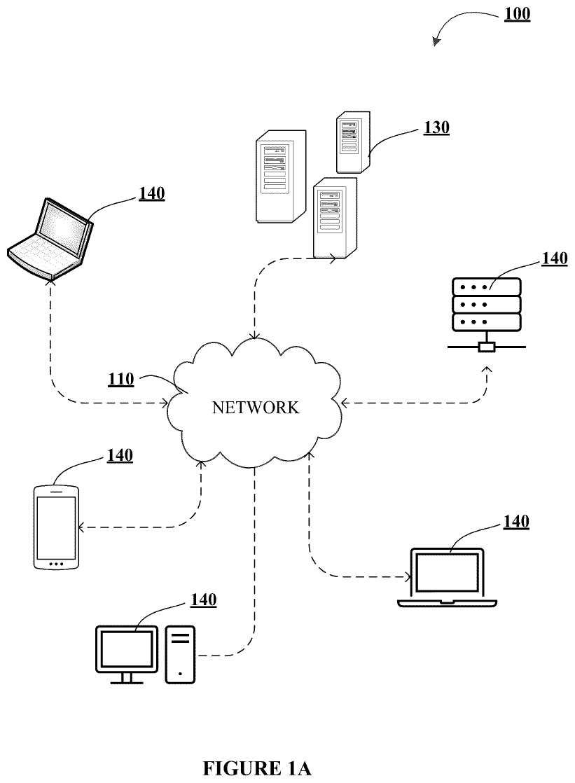

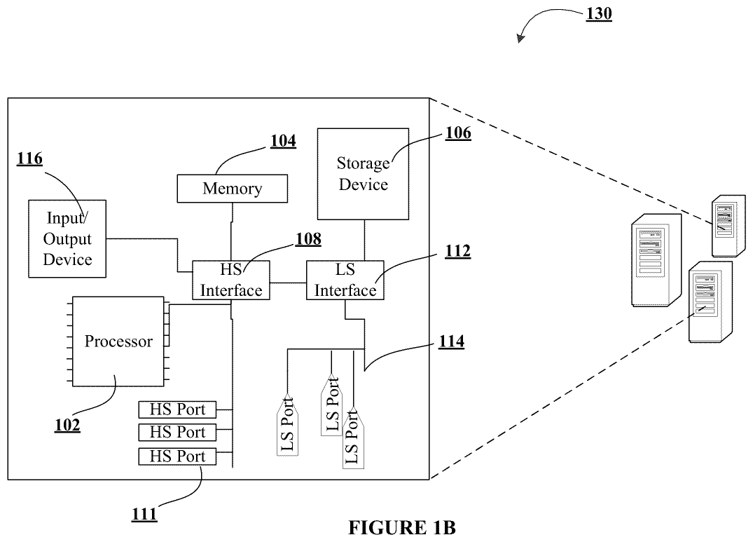

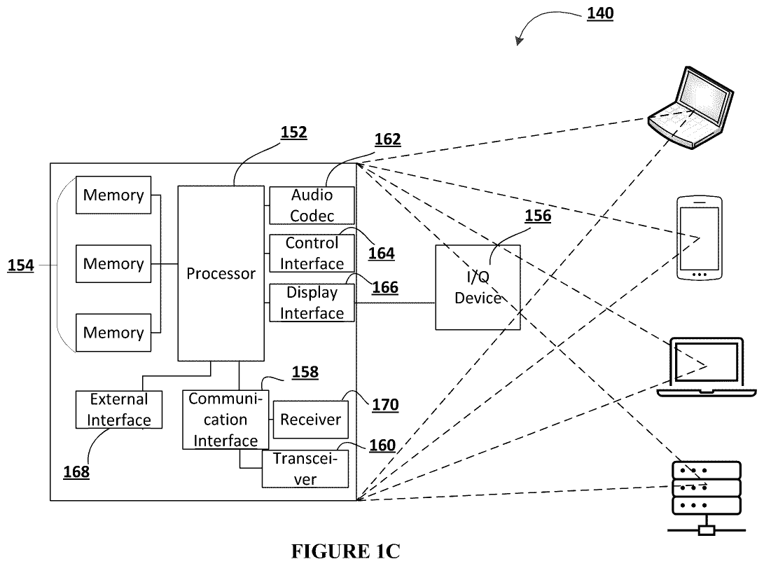

FIGS. 1A-1C illustrate technical components of an exemplary distributed computing environment for determining a computing system's current state by implementing state machines and knowledge graphs in an electronic environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

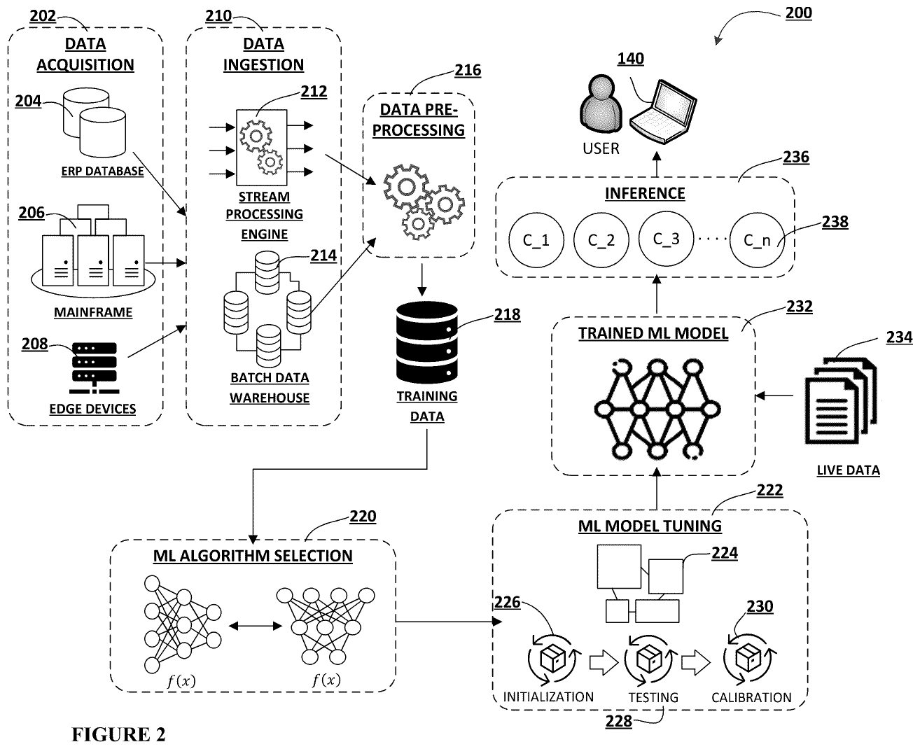

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

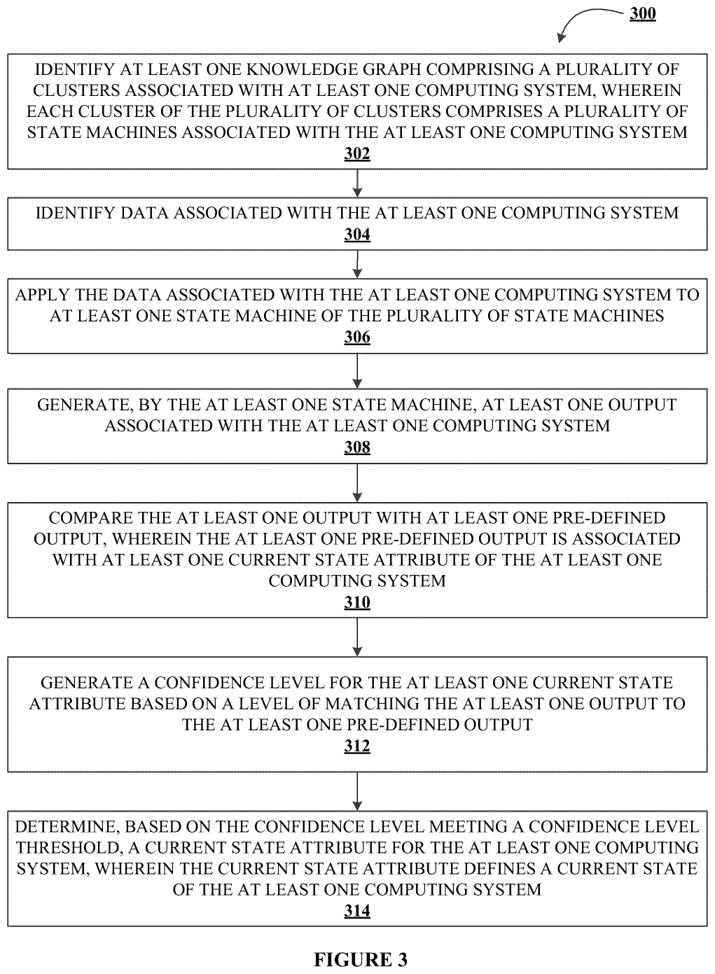

FIG. 3 illustrates a process flow 300 for determining a computing system's current state by implementing state machines and knowledge graphs in an electronic environment, in accordance with an embodiment of the disclosure. In some embodiments, a system (e.g., similar to one or more of the systems described herein with respect to FIGS. 1A-1C and 2) may perform one or more of the steps of process flow 300. For example, a system (e.g., the system 130 described herein with respect to FIG. 1A-1C) may perform the steps of process 300. For example, a trained machine learning model (e.g., the system 232 described herein with respect to FIG. 2) and/or a computation model may perform some steps of process 300.

As shown in block 302, the process flow 300 may include the step of identifying at least one knowledge graph comprising a plurality of clusters associated with at least one computing system, wherein each cluster of the plurality of clusters comprises a plurality of state machines associated with the at least one computing system.

As used herein, the term “knowledge graph” refers to a formation, organization, and/or configuration of nodes that represent objects (such as computing system components and/or the like) and the relationships between the objects. For instance, and where computing system components interact with the other computing system components within a network, a knowledge graph may connect each of the interacting computing components with edges. In some embodiments, the knowledge graphs may further comprise labels which define the relationship and/or the data transmitted between the nodes of the knowledge graphs. Further and as used herein, the nodes of the knowledge graph may comprise the clusters described herein.

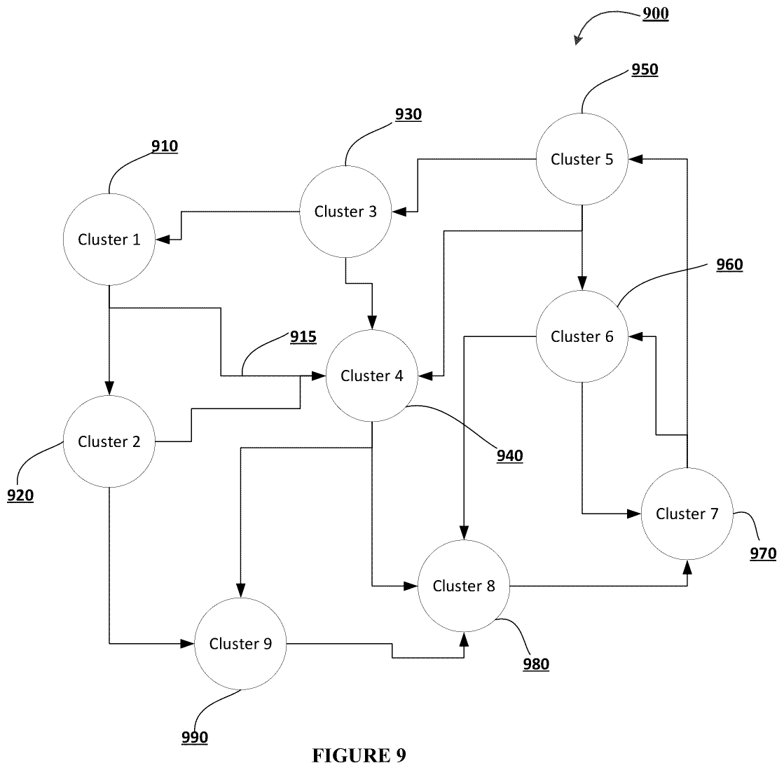

By way of example, the system may identify at least one knowledge graph based on accessing a database of information, an index of information, and/or the like comprising relationships and data transmissions between components of a computing system(s). In some embodiments, the identification of the at least one knowledge graph may be based on accessing a database which has already pre-stored the at least one knowledge graph, whereby the system may access the at least one knowledge graph and analyze the at least one knowledge graph. In some embodiments, the system may identify the at least one knowledge graph by receiving a pre-generated knowledge graph from a source that created the knowledge graph (such as from a user device that manually generated the knowledge graph, and/or the like). In some embodiments, the system may receive and/or identify the knowledge graph once the knowledge graph has been generated by a machine learning model (like that described with respect to FIG. 2) and/or a computational model. Additionally, and as shown herein, an exemplary knowledge graph is shown and described below with respect to FIG. 9.

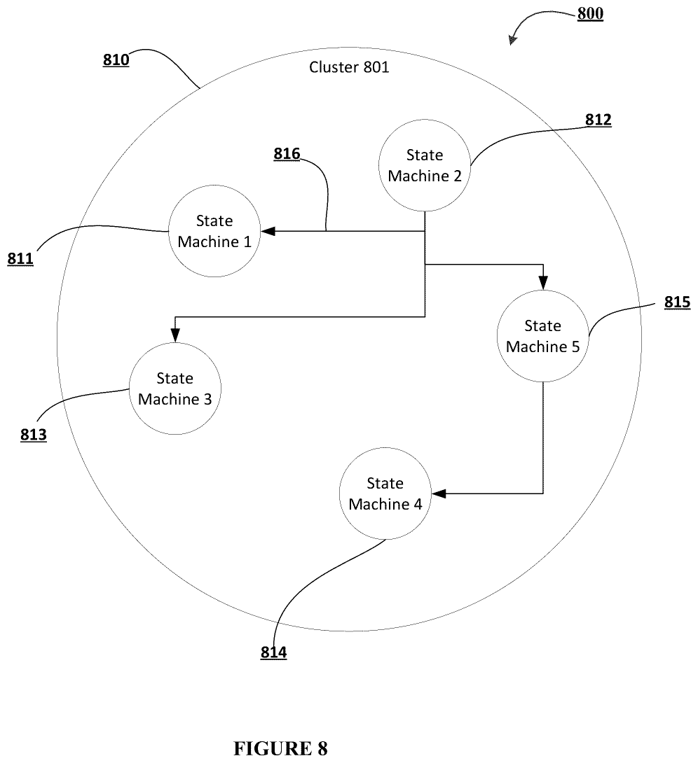

Additionally, and as used herein, the term “cluster” or “clusters” refers to an organization, formation, and/or configuration of a plurality of state machines, which may be organized based on the functions and activities of each state machine within the cluster(s). For instance, and where a plurality of computing system components are interacting with each other (such as by transmitting data, interacting with the same data, and/or the like) and/or where the plurality of computing system components have the same function, each of the plurality of computing system components may be organized into a cluster. Additionally, and as shown herein, an exemplary cluster is shown and described below with respect to FIG. 8.

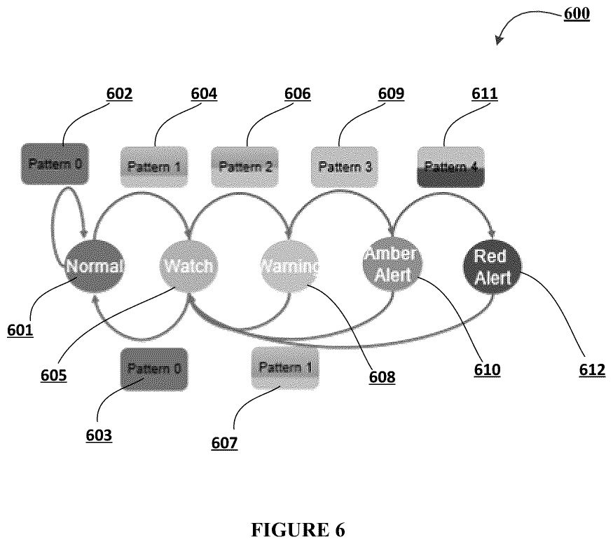

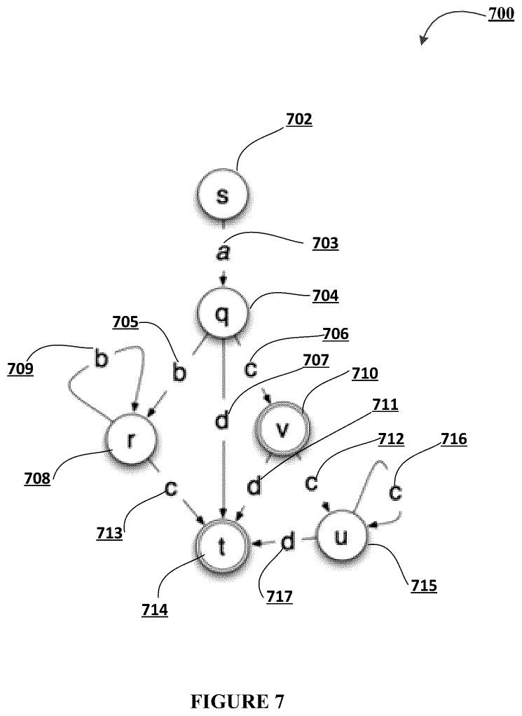

As used herein, the term “state machine” or “state machines” refers to a mathematical model of computation which shows the potential states and their transitions that a computing component may have been in or may currently be in based on inputs received (e.g., such as data received regarding the component's current usage). Such inputs may be referred to as events, whereby such an event may cause the state machine to transition from a previous state to a new or current state based on the rule for each state. Additionally, and as shown herein, an exemplary state machine is shown and described below with respect to FIGS. 6 and 7.

As used herein, the term “computing system” refers to a system and/or structure of one or more computers and/or components within at least one computer that interact and transmit data within a network. In some embodiments, the computing system may comprise one or more computers and associated software and hardware that share a common storage.

As shown in block 304, the process flow 300 may include the step of identifying data associated with the at least one computing system. For instance, the system may identify data associated with the at least one computing system once a computing system component has started a function, completed a function, and/or the like. In some embodiments, the data may be identified for the at least one computing system based on a continuous examination of the data regarding each computing system component, including but not limited to current usage, current storage capacity, and/or the like. In some embodiments, the continuous examination may occur at pre-defined intervals (e.g., every second, every five seconds, every ten seconds, every thirty seconds, every minute, and/or the like). In some embodiments, such a pre-defined interval may be determined by the system itself, by a manager of the system, by a client of the system, and/or the like.

As shown in block 306, the process flow 300 may include the step of applying the data associated with the at least one computing system to at least one state machine of the plurality of state machines. For example, the system may apply the data associated with the at least one computing system to at least one state machine of the plurality of state machines in order for the data to be used as input and/or an event for the at least one state machine. Further, the data may be assigned as an input and/or event to a particular state machine (or a plurality of particular state machines) based on a computing component identifier associated with each state machine, whereby the computing component identifier associated with each state machine may be compared and matched to the computing component identifier that is associated with the data (e.g., the computing component that generates the data, the computing component that uses the data, the computing component that receives the data, and/or the like).

Similarly, and in some embodiments, the at least one output associated with the at least one computing system is associated with the computing component identifier. In this manner, the system may associate the output data from a computing component and/or an overall system comprising the computing component with a computing component identifier and use the computing component identifier to transmit the output data to a particular state machine or a plurality of particular state machines.

In some embodiments, the data associated with the at least one computing system and received by a state machine is based on at least one data subscription. Such a data subscription may automatically determine and transmit which state machines and/or which clusters are meant to receive what data. In some embodiments, the data subscription(s) are used to transmit data automatically between state machines, automatically between clusters, and/or the like. Thus, and simply put, the data subscription(s) may be used to automatically transmit data, transmit events, transmit outputs/states, and/or the like between state machines and/or clusters comprising state machines. Such an embodiment may be useful in an instance where one state machine's state and/or output would affect a different state machine's state and/or output.

In some embodiments, the application is based on a data subscription for receiving data which may be associated with at least one of a transmitting state machine, a receiving state machine, a receiving cluster, and/or a transmitting cluster. In this manner, the at application of data is automatically transmitted and received by at least one state machine (or a plurality of state machines) and/or at least one cluster (or a plurality of clusters).

As shown in block 308, the process flow 300 may include the step of generating—by the at least one state machine—at least one output associated with the at least one computing system. For example, the system may generate—using the at least one state machine—at least one output and/or at least one state based on the data associated with the at least one computing system being applied to the state machine(s). In some embodiments, such an output and/or state may be used as a final output to the state machine and/or may be used as only a piece of an output to the state machine. Similarly, and in some embodiments, after each state of each state machine is generated (e.g., at each step of the state machine) has been generated, the current state of the state machine may be used to determine whether the computing system component is acting in accordance with its system requirements (e.g., whether the computing system component is not about to overheat, is not about to run out storage, is operating with optimal processing speeds, is not about to operate with low or minimal processing speeds, and/or the like).

As shown in block 310, the process flow 300 may include the step of comparing the at least one output with at least one pre-defined output, wherein the at least one pre-defined output is associated with at least one current state attribute of the at least one computing system. As used herein, the pre-defined output may comprise a pre-defined set of circumstances, a pre-defined indicator for the computer system component (such as an indicator indicating an overload, a low available storage capacity, an overheating indicator, and/or the like), and/or the like.

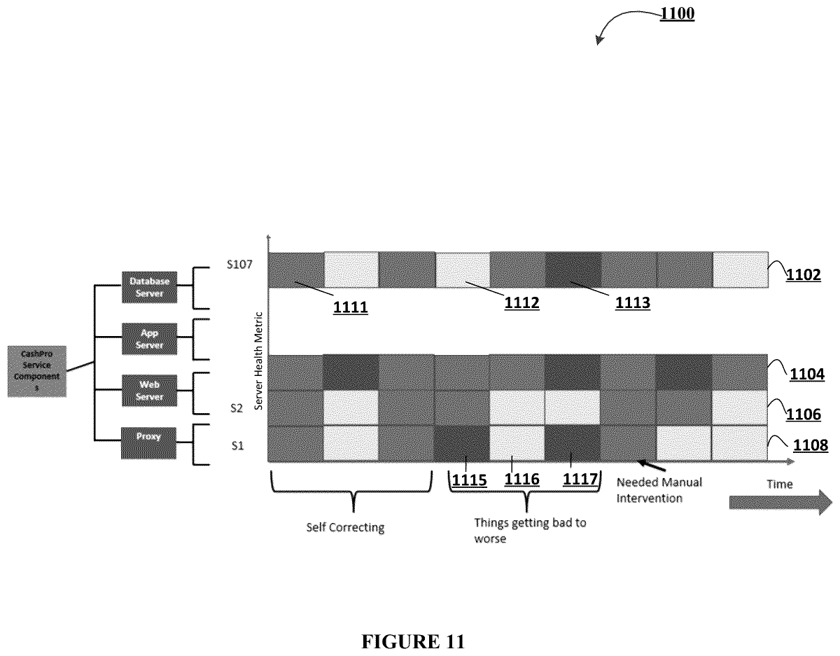

For example, the system may compare the at least one output and/or state of the state machine(s) against a pre-defined output and/or state in order to determine a current and future state of the computing system component or overall computing system. In this manner, the system may use all of the states previously and currently generated for a state machine (such as those generated at a current time or immediately previous time) and compare the state(s) at each generation of a new state to a pre-defined output, where each pre-defined output may be used as a guide to determine what overall state the computing system component is in currently or will be in (e.g., imminently). In some embodiments, the pre-defined output may comprise a pre-defined pattern, such as a pre-defined pattern of states for a state machine(s). Such an example of a pre-defined output is shown and described below with respect to FIG. 11.

As shown in block 312, the process flow 300 may include the step of generating a confidence level for the at least one current state attribute based on a level of matching the at least one output to the at least one pre-defined output. For example, the system may generate a confidence level for the at least one current state (and based on the previously generated states for the state machine) on how likely it is to match the at least one pre-defined output.

Additionally, and in some embodiments, the confidence level generated may be compared against and/or compared to a confidence level threshold. Such a confidence level threshold may be pre-defined and used as a metric to show that the output of the state machine likely matches the pre-defined output, such as where not all of the states of the state machine has been generated.

As shown in block 314, the process flow 300 may include the step of determining—based on the confidence level meeting a confidence level threshold—a current state attribute for the at least one computing system, wherein the current state attribute defines a current state of the at least one computing system. For example, the system may determine—based on the generated confidence level—whether the confidence level meets or exceeds the confidence level threshold after each state of the state machine is generated. In this manner, the system may determine as quickly as possible whether a potential error or issue may arise at a future time for the computer system and/or for a particular computing system component.

In some embodiments, and where the confidence level does not meet or exceed the confidence level threshold, the system may determine that the pre-defined output could not be determined to match the output(s) or state(s) so far for the state machine(s), and the system may continue to collect data and determine new state(s) for the state machine(s).

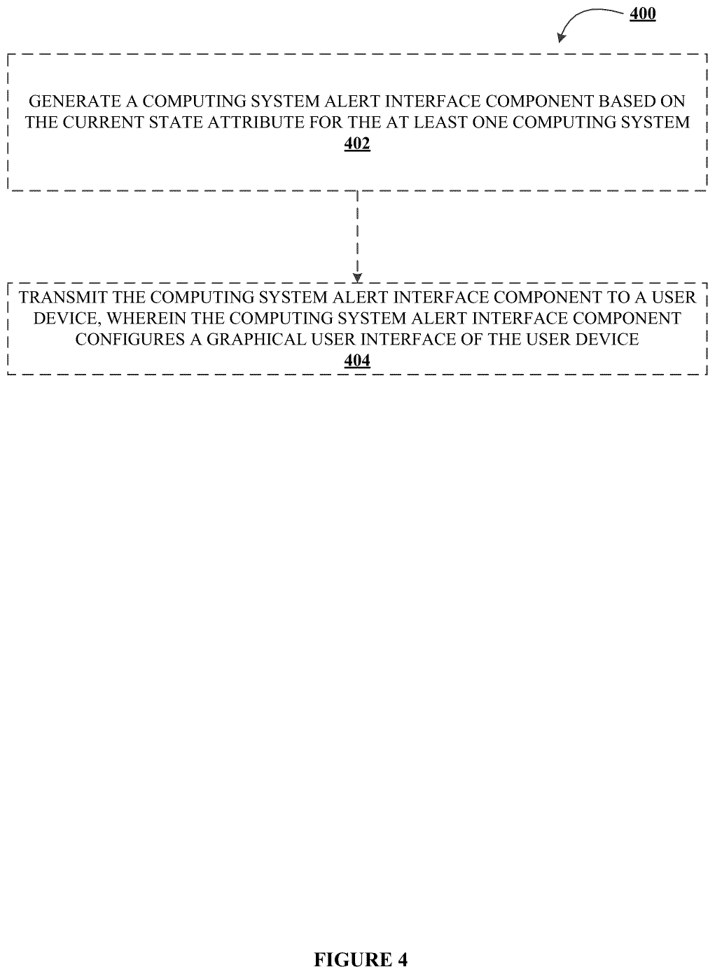

As used herein, the current state attribute is used to identify the current state of the computing system component and/or the overall computing system, whereby such a current state attribute may indicate—in computer readable language—how the computing system component and/or overall computing system is performing or will likely imminently perform. In some embodiments, such a current state attribute may comprise at least one of a “watch state,” a “warning state,” an “amber alert” or “orange alert,” a “normal state,” a “red alert” or “emergency alert,” and/or the like. Based on each of these current state attributes, and once at least one has been determined for the computing system component and/or the overall computing system, the system may use the current state attribute to show an alert to a user associated with the system (such as a computing system alert interface component, which is described in further detail below with respect to FIG. 4), and such an alert may be used to automatically configure a graphical user interface (GUI) of a user device to show the alert in real time.

FIG. 4 illustrates a process flow 400 for generating and transmitting the computing system alert interface component to a user device, in accordance with an embodiment of the disclosure. In some embodiments, a system (e.g., similar to one or more of the systems described herein with respect to FIGS. 1A-1C and 2) may perform one or more of the steps of process flow 400. For example, a system (e.g., the system 130 described herein with respect to FIG. 1A-1C) may perform the steps of process 400. For example, a trained machine learning model (e.g., the system 232 described herein with respect to FIG. 2) and/or a computation model may perform some steps of process 400.

In some embodiments, and as shown in block 402, the process flow 400 may include the step of generating a computing system alert interface component based on the current state attribute for the at least one computing system. For example, the system may generate a computing system alert interface component, whereby such a computing system alert interface component comprises at least the current state attribute of the at least one computing system, the overall computing system, at least one computing system component, and/or the like. In some embodiments, the computing system alert interface component may additionally comprise an identifier of the individual computing system component(s) that the current state attribute(s) are describing.

In some embodiments, the computing alert interface component may comprise a different pattern, color, indicator, and/or the like for each of the current state attributes. For instance, each current state attribute type may comprise a different color or highlight on a chart indicating the past and current states for each computing system component or each computing system. By way of non-limiting example, a “Normal state” may be indicated with a green highlight, an “Emergency alert” may be indicated with a red highlight, and an “amber alert” may be indicated by a yellow highlight. Such an exemplary computing system alert interface component comprising different colors and/or patterns is shown and described below with respect to FIG. 11.

In some embodiments, and as shown in block 404, the process flow 400 may include the step of transmitting the computing system alert interface component to a user device, wherein the computing system alert interface component configures a graphical user interface (GUI) of the user device. Such a computing system alert interface component may be transmitted from the system to a user device associated with the system (such as a user device of a client of the system, a user device associated with a manager of the system, and/or the like) and may be used to automatically configure the GUI of the user device to at least show the at least one current state attribute. In some embodiments, the user device associated with a client of the system may comprise a user device associated with an information technology (IT) member of a client, whereby the client's computing system is the computing system being analyzed by the system. In this manner, an alert may automatically be transmitted to the user device and configure the GUI of the user device to show the IT member how each of the computing system(s) and/or how each of the computing system components are performing or will imminently perform.

In some embodiments, only those current state attributes comprising an amber alert, an orange alert, a red alert, or an emergency alert may be used to generate the computing system alert interface component which automatically configures the GUI of a user device. In this manner, an automatic alert is transmitted only for those computing systems and/or computing system components that have a current major problem (or have an imminent major problem) or are likely to have a current major problem (or are likely to have an imminent major problem). Thus, and in this embodiment, the computing system alert interface component may automatically be transmitted to the user device and configure the GUI of the user device in the instance where the current state attribute comprises a medium or high alert. In some embodiments, the computing system alert interface component may only comprise those current state attributes with a red or emergency alert (e.g., indicating a high alert) and may only automatically configure a GUI of the user device in that instance.

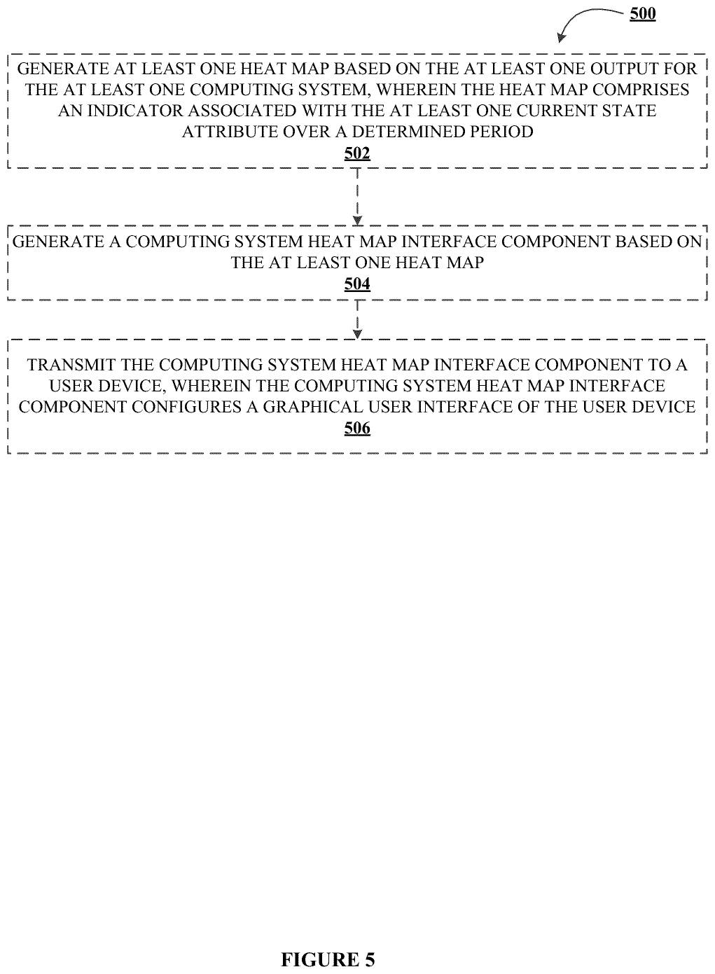

FIG. 5 illustrates a process flow 500 for generating and transmitting a computing system heat map interface component, in accordance with an embodiment of the disclosure. In some embodiments, a system (e.g., similar to one or more of the systems described herein with respect to FIGS. 1A-1C and 2) may perform one or more of the steps of process flow 500. For example, a system (e.g., the system 130 described herein with respect to FIG. 1A-1C) may perform the steps of process 500. For example, a trained machine learning model (e.g., the system 232 described herein with respect to FIG. 2) and/or a computation model may perform some steps of process 500.

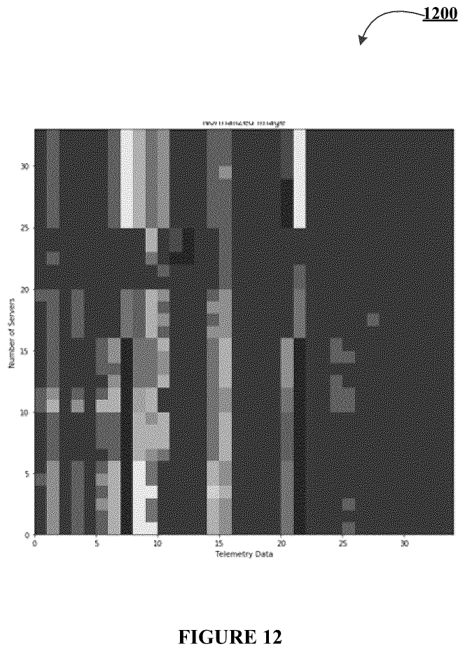

In some embodiments, and as shown in block 502, the process flow 500 may include the step of generating at least one heat map based on the at least one output for the at least one computing system, wherein the heat map comprises an indicator associated with the at least one current state attribute over a determined period. For example, the system may generate at least one heat map based on the at least one output (e.g., state) for the computing system (and/or for each individual computing system component). In some embodiments, the heat map may be used to show-visually-how the computing system has performed and is currently performing. In some embodiments, a heat map may be used to show each computing system component, whereby a plurality of heat maps may be used to show a plurality of computing system components, individually. In some embodiments, the computing system alert interface component may further comprise a heat map like that shown herein, such that at least one heat map may be used to configure a GUI of a user device and shown on a user device's user interface. An exemplary heat map is shown and described in further detail below with respect to FIG. 12.

In some embodiments, and as shown in block 504, the process flow 500 may include the step of generating a computing system heat map interface component based on the at least one heat map. For instance, the system may generate computing system heat map interface component in addition to and/or alternatively to the computing system alert interface component. In some embodiments, the computing system heat map interface component may comprise data regarding the overall computing system, telemetry data regarding each of the computing system components within the computing system, and how each of the computing system components are performing and have performed. In some embodiments, such a heat map may further comprise a color highlighting and/or color indicators for each of the states of the computing system components. Such color highlighting and/or color indicators may be similar to those described above with respect to FIG. 4.

In some embodiments, and as shown in block 506, the process flow 500 may include the step of transmitting the computing system heat map interface component to a user device, wherein the computing system heat map interface component configures a graphical user interface (GUI) of the user device. For example, the system may transmit the computing system heat map interface component to a user device associated with the system (e.g., a user device associated with a client of the system, a user device associated with a manager of the system, and/or the like), whereby the computing system heat map interface component may automatically configure the GUI of the user device to show the heat map(s) to a user of the user device. For instance, and where the user device is associated with an IT member of a client for the system, the IT member may view the heat map(s) shown on the configured GUI of the user device and determine whether the overall computing system is working accordingly or is likely to have imminent errors or problems.

FIG. 6 illustrates an exemplary state machine 600, in accordance with an embodiment of the disclosure. In some embodiments, a system (e.g., similar to one or more of the systems described herein with respect to FIGS. 1A-1C and 2) may perform one or more of the steps in generating and operating state machine 600. For example, a system (e.g., the system 130 described herein with respect to FIG. 1A-1C) may perform the steps of generating and operating state machine 600. For example, a trained machine learning model (e.g., the system 232 described herein with respect to FIG. 2) and/or a computation model may perform some steps of generating and operating state machine 600.

By way of example, an exemplary state machine 600 is shown, whereby such an exemplary state machine 600 may comprise a plurality of states (e.g., state 601, state 605, state 608, state 610, state 612, and/or the like), a plurality of patterns or transitions (e.g., pattern 0 602 or 603, pattern 1 604 or 607, pattern 2 606, pattern 3 609, pattern 4 611, and/or the like), and events or inputs which are what decide the pattern selected or transition and the next state that will occur.

For example, and based on exemplary state machine 600, the state machine may begin in state zero (commonly referred to as “S₀”) or pattern 0 602 which may recycle to the normal state 601 until an input is received that may cause the sate machine to transition based on the new input matching pattern 1 604. Such an input that matches pattern 1 while the state machine is at the normal state 601 will cause the state machine to transition to the watch state 605. In some embodiments, and while the state machine is at watch state 0, if the next input received matches pattern 0 603, then the state machine will transition back to normal state 601 from the watch state 605. In some embodiments, and where the state machine is at the watch state 605 and the input received matches pattern 2 606, then the state machine may transition from watch state 605 to warning state 608.

Similarly, and where the state machine is currently at the warning state 608 and an event or input is received that matches pattern 3 609, then the state machine may transition from the warning state 608 to the amber alert state 610. In contrast, and where the state machine is currently at the warning state 608 and an event or input is received that matches pattern 1 607 (which may also match pattern 1 604), then the state machine may transition from the warning state 608 to the watch state 605.

Additionally, and in the embodiments where the state machine is currently at the amber alert state 610 and an input is received that matches pattern 4 611, then the state machine may transition from amber alert state 610 to red alert 612. Such a red alert, in some embodiments, may be used to determine that an emergency or major error is about to occur or has already occurred within a computing system, such as the computing system described herein, and an emergency alert may be generated and transmitted to a user device (similar to the process described above). Additionally, and where the amber alert state 610 is reached by the state machine, an indication that an error may occur for the computing system may be generated, such as an orange alert like that described above.

Additionally, and similar to the disclosure above, and where an input is received at either the amber alert state 610 and/or the red alert state 612, and the input matches pattern 1 607, then the state machine may transition back to the watch state 607.

FIG. 7 illustrates an exemplary state machine with continuous pattern analysis 700 comprising a plurality of state machines, in accordance with an embodiment of the disclosure. In some embodiments, a system (e.g., similar to one or more of the systems described herein with respect to FIGS. 1A-1C and 2) may perform one or more of the steps in generating and operating exemplary state machine 700. For example, a system (e.g., the system 130 described herein with respect to FIG. 1A-1C) may perform the steps of generating and operating exemplary state machine 700. For example, a trained machine learning model (e.g., the system 232 described herein with respect to FIG. 2) and/or a computation model may perform some steps of generating and exemplary state machine 700.

By way of example, a state machine (similar to the state machine described above with respect to FIG. 6 and described herein with respect to FIG. 7) may be used by the system to predict the state of a computing system (e.g., the current state and the imminent state). For example, and as shown in state machine 700, state machine 700 may begin in state 0 (″S) 702 and move through each of the other states (e.g., state q 704, state r 708, state t 714, state v 710, state u 715, and/or the like) upon receiving inputs or events and moving through the state transitions between each state (state transition a 703; state transition b 705 and/or 709; state transition c 706, 711, 712, 713, and/or 716; state transition d 707, 711, and 717; and/or the like) which depend on which current state the state machine is in.

Similar to the disclosure above with respect to FIG. 6, the state machine 700 may start at state s 702 (e.g., state zero) and based on receiving an input that matches pattern a 703 (e.g., state transition a 703), the state machine may transition to state q 704. In some embodiments, and based on receiving an input that matches state transition b 705, state transition d 707, or state transition c 706, the state machine may transition to state r 708, state t 714, or state v 710, respectively. In some embodiments, and where the state machine 700 is currently at state r 708, and where an input is received that matches state transition b 709 (which matches the same pattern as state transition b 705), then the state machine may stay in state r 708. In some embodiments, and where state machine 700 is currently at state r 708, and where an input is received that matches state transition c 713 (which matches the same pattern as state transition c 706, 712, and 716), then the state machine may transition to state t 714.

In some embodiments, and where the state machine is currently at state v 711, and if the input received matches state transition c 712 or state transition d 711, then the state machine may transition to state u 715 or state t 714, respectively. In some embodiments, and where the state machine is currently at state u 715, and the input received matches state c 716 or state d 717, then the state machine may stay at state u 715 or transition to state t 714, respectively. In each of these embodiments, described herein, each of the states of the state machines besides state zero (e.g., state r 708, state q 704, state v 710, or state u 715) may transition tot state t 714 as the end-state. In some embodiments, however, multiple of these states may continuously stay in their state based on receiving the same input as the state transition that caused the state machine to transition to its current state (e.g., where the state machine is in state r 708 based on receiving an input matching state b 705, then the state machine may be stay in the same state b 705 if it receives the same input that matches state b 705—and 709—again). In this manner, the state machine may continuously state in a current state until a new input is received that does not match the most-previously received input.

FIG. 8 illustrates an exemplary cluster 800 comprising a plurality of state machines, in accordance with an embodiment of the disclosure. In some embodiments, a system (e.g., similar to one or more of the systems described herein with respect to FIGS. 1A-1C and 2) may perform one or more of the steps in generating and operating cluster 800. For example, a system (e.g., the system 130 described herein with respect to FIG. 1A-1C) may perform the steps of generating and operating cluster 800. For example, a trained machine learning model (e.g., the system 232 described herein with respect to FIG. 2) and/or a computation model may perform some steps of generating and operating cluster 800.

As shown in exemplary cluster 800, a cluster (e.g., cluster 801) may comprise a plurality of state machines (e.g., state machine 1 811, state machine 2 812, state machine 3 813, state machine 4 814, state machine 5 815, and/or the like). As shown herein, a cluster-like that described above with respect to FIGS. 3-5) may comprise a plurality of state machines that interact with each other, such as by transmitting data, transmitting output states, and/or the like. For instance, cluster 801 comprises a state machine 2 812 that transmits data and/or output state(s) to state machine 1 811 (e.g., as shown by arrow 816), state machine 5 815, and state machine 3 813. In some embodiments, the data and/or output states may be transmitted between state machines based on a data subscription such as the data subscription described above with respect to FIG. 3. Similarly, state machine 5 815 may share a data subscription with state machine 4 814, such that state machine 5 815 automatically transmits data or a state output to state machine 4 814.

FIG. 9 illustrates an exemplary knowledge graph 900 comprising a plurality of clusters, in accordance with an embodiment of the disclosure. In some embodiments, a system (e.g., similar to one or more of the systems described herein with respect to FIGS. 1A-1C and 2) may perform one or more of the steps in generating and operating knowledge graph 900. For example, a system (e.g., the system 130 described herein with respect to FIG. 1A-1C) may perform the steps of generating and operating knowledge graph 900. For example, a trained machine learning model (e.g., the system 232 described herein with respect to FIG. 2) and/or a computation model may perform some steps of generating and operating knowledge graph 900.

By way of example, exemplary knowledge graph 900 may comprise a plurality of clusters (e.g., cluster 1 910, cluster 2 920, cluster 3 930, cluster 4 940, cluster 5 950, cluster 6 960, cluster 7 970, cluster 8 980, cluster 9 990, and/or the like). Similar to the disclosure provided above with respect to FIG. 8, each of the clusters within a knowledge graph may interact with each other or comprise similar components or data. For instance, each of the knowledge graphs used by the system may store interlinked descriptions of components or entities (e.g., objects, events, situations, inputs, outputs, states, and/or the like) and the underlying encoded semantics or logic for each of the descriptions. For each of the interlinked descriptions of components, the knowledge graph may comprise a corresponding interlinking between clusters (e.g., where one cluster is associated with component A and a second cluster is associated with component B, and component A and component B comprise interlinked descriptions, then the knowledge graph may comprise data transmission linkage between the clusters). Such a data transmission linkage may comprise an automatic data transmission from one cluster to a second cluster (e.g., such that an output state may bet transmitted between clusters, input data may be transmitted, output data may be transmitted, and/or the like), like that shown between cluster 1 910 and cluster 4 940 (as indicated by arrow or edge 915).

In some embodiments, each cluster within the knowledge graph may comprise different types of state machines, different numbers of state machines, and/or the like, which may be depend on the functions and activities of the state machines themselves individually, or on the cluster's functions and activities. In some embodiments, the clusters and their associated communications and data transmissions are based on the data subscriptions like those described above with respect to FIGS. 3-5 and 8.

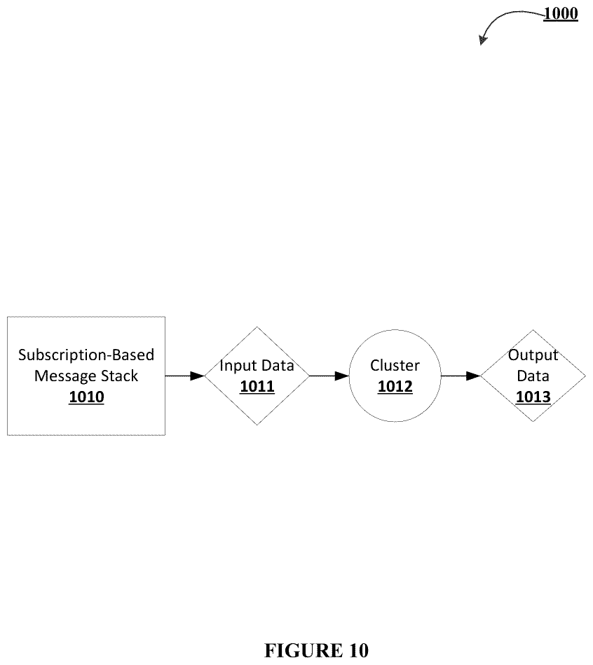

FIG. 10 illustrates an exemplary data flow for data subscriptions 1000, in accordance with an embodiment of the disclosure. In some embodiments, a system (e.g., similar to one or more of the systems described herein with respect to FIGS. 1A-1C and 2) may perform one or more of the steps in generating and operating the data flow for data subscriptions 1000. For example, a system (e.g., the system 130 described herein with respect to FIG. 1A-1C) may perform the steps of generating and operating data flow for data subscriptions 1000. For example, a trained machine learning model (e.g., the system 232 described herein with respect to FIG. 2) and/or a computation model may perform some steps of generating and operating data flow for data subscriptions 1000.

By way of example, the system may identify a subscription-based message stack 1010, whereby the subscription-based message stack comprises at least one data subscription for at least one cluster and/or state machine associated with at least one computing system component. Such a subscription-based message stack 1010 refers to a computer-readable message for the system, which identifies which data should be automatically transmitted to each state machine and/or to each cluster within the system automatically, how often the data should be transmitted, and whether the data is transmitted between state machines and/or between clusters. Such data identified in the subscription-based message stack may be used to identify the input data 1011 for each cluster 1012 (and/or for each state machine within each cluster 1012), and upon receiving the input data 1011 the cluster 1012 may generate an expected output data 1013. In some embodiments, the subscription-based message stack may additionally and/or alternatively apply to the output data 1013 generated, such that the output data 1013 may likewise be automatically transmitted to another cluster and/or state machine.

FIG. 11 illustrates an exemplary computing system alert interface component 1100 comprising current states and immediately previous states for the computing system and its components which is used to determine the state of the computing system and its component(s), in accordance with an embodiment of the disclosure. In some embodiments, a system (e.g., similar to one or more of the systems described herein with respect to FIGS. 1A-1C and 2) may perform one or more of the steps of generating exemplary computing system alert interface component 1100. For example, a system (e.g., the system 130 described herein with respect to FIG. 1A-1C) may perform the of the steps of generating exemplary computing system alert interface component 1100. For example, a trained machine learning model (e.g., the system 232 described herein with respect to FIG. 2) and/or a computation model may perform some of the steps of generating computing system alert interface component 1100.

By way of example, the computing system alert interface component 1100 may comprise a plurality of alerts and/or indicators (e.g., which may each comprise their own patterns, color highlighting, and/or the like) to indicate the current state of each computing system component (e.g., such as each of the servers within a computing system, like the database server of row 1, the application server of row 2, the web server of row 3, the proxy server of row 4, and/or the like). Each of the computing system components may be associated with their own row of states over a time period, whereby a single block of a state (e.g., comprising a green block (as shown as block 1111), a yellow/orange block (as shown as block 1112), or a red block (as shown as block 1113) may indicate the state of the computing system component to be normal (e.g., green block 1111), warning or needing attention (e.g., yellow block 1112), or emergency or red alert (e.g., red block 1113). In some embodiments, and where the states of a computing system component comprise yellow/orange and red indicators directly next to each other in time, the system may be configured to generate an automatic alert and transmit the alert to a user device associated with the system such that the error may be correct. Such a pattern of red and orange/yellow blocks or states may be used by the system to compare against pre-defined outputs in order to determine a next step for the system (e.g., transmitting an alert to a user interface, conducting a fix on the computing system component, requesting manual intervention, and/or the like). For instance, a pattern similar to the plurality of blocks shown in row 1108 for the proxy server (whereby blocks 1115 (shown as a red block), 1116 (shown as a yellow/orange block), and 1117 (shown as a red block) may be used as a comparison to a pre-defined pattern) may indicate that the proxy server's current state was “getting bad to worse” and would likely need intervention-such as manual intervention to return to a normal state. Such a determination may be based on the comparison of the blocks to a pre-defined pattern or output of the same or similar blocks, and may be used by the system to determine what kind of alert—if any to generate and transmit—and whether intervention of the computing system component is necessary.

FIG. 12 illustrates an exemplary computing system heat map interface component 1200 comprising current states and indicators for the computing system and its components, in accordance with an embodiment of the disclosure. In some embodiments, a system (e.g., similar to one or more of the systems described herein with respect to FIGS. 1A-1C and 2) may perform one or more of the steps of generating exemplary computing system heat map interface component 1200. For example, a system (e.g., the system 130 described herein with respect to FIG. 1A-1C) may perform the of the steps of generating exemplary computing system heat map interface component 1200. For example, a trained machine learning model (e.g., the system 232 described herein with respect to FIG. 2) and/or a computation model may perform some of the steps of exemplary computing system heat map interface component 1200.

By way of example, the computing system heat map interface component 1200 may comprise data and indicators (such as color indicators) regarding the overall computing system and/or individual computing system components and how they are performing in the overall computing system. For instance, and where a computing system component is performing poorly, the heat map may indicate the poor performance with a red indicator or red color highlighting in the heat map. In some embodiments, closely related components may be situated closer together in the heat map, such that the poor performance of one computing component that often interacts within a secondary component will affect the color highlighting of the secondary component in the heat map (e.g., where the first component is performing poorly and has a red highlighting and where the secondary component has yellow highlighting, then the heat map may be configured to show an orange hue or color between the components). In this manner, the computing system heat map interface component may show each computing component and it's overall affects on the surrounding computing components within the computing system.

In some embodiments, the heat map may comprise a normalized image of the states and color indicators for each of the computing system components, such that the data of the heat map (e.g., the coloration for each pixel) is clustered and such that the states of each computing system component are on a similar scale when determining which computing system component(s) should be dealt with first (e.g., the reddest of the computing system components should likely be dealt with first). In some embodiments, such a normalized heat map may additionally be used to determine which computing system components have the most far-reaching effect on the other computing system components within the computing system (e.g., a large cluster of red and orange hued pixels should be dealt with first before a smaller cluster of red and orange hued pixels).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining a computing system's current state by implementing state machines and knowledge graphs, the system comprising:
a memory device with computer-readable program code stored thereon;
at least one processing device, wherein executing the computer-readable code is configured to cause the at least one processing device to perform the following operations:
identify at least one knowledge graph comprising a plurality of clusters associated with at least one computing system, wherein each cluster of the plurality of clusters comprises a plurality of state machines associated with the at least one computing system;
identify data associated with the at least one computing system;
apply the data associated with the at least one computing system to at least one state machine of the plurality of state machines;
generate, by the at least one state machine, at least one output associated with the at least one computing system;
compare the at least one output with at least one pre-defined output, wherein the at least one pre-defined output is associated with at least one current state attribute of the at least one computing system;
generate a confidence level for the at least one current state attribute based on a level of matching the at least one output to the at least one pre-defined output; and
determine, based on the confidence level meeting a confidence level threshold, a current state attribute for the at least one computing system, wherein the current state attribute defines a current state of the at least one computing system.

2. The system of claim 1, wherein the application of the data is based on a computing component identifier of the at least one state machine.

3. The system of claim 2, wherein the at least one output associated with the at least one computing system is associated with the computing component identifier.

4. The system of claim 1, wherein the at least one pre-defined output comprises a pre-defined pattern.

5. The system of claim 1, wherein the confidence level is determined based on a likelihood of the at least one output to the at least one pre-defined output match.

6. The system of claim 1, wherein the data associated with the at least one computing system is received by a state machine is based on at least one data subscription.

7. The system of claim 6, wherein the at least one data subscription is associated with at least one state machine which transmits the data or at least one state machine which receives the data, and wherein the data subscription automatically causes a data transmission of the data to the at least one state machine which receives the data.

8. The system of claim 1, wherein the computer-readable code is configured to cause the at least one processing device to perform the following operations:
generate a computing system alert interface component based on the current state attribute for the at least one computing system; and
transmit the computing system alert interface component to a user device, wherein the computing system alert interface component configures a graphical user interface of the user device.

9. The system of claim 9, wherein the computing system alert interface component is automatically transmitted to the user device and configures the graphical user interface of the user device in an instance where the current state attribute comprises a high alert.

10. The system of claim 1, wherein the computer-readable code is configured to cause the at least one processing device to perform the following operations:
generate at least one heat map based on the at least one output for the at least one computing system, wherein the heat map comprises an indicator associated with the at least one current state attribute over a determined period;
generate a computing system heat map interface component based on the at least one heat map; and
transmit the computing system heat map interface component to a user device, wherein the computing system heat map interface component configures a graphical user interface of the user device.

11. A computer program product for determining a computing system's current state by implementing state machines and knowledge graphs, wherein the computer program product comprises at least one non-transitory computer-readable medium having computer-readable program code portions embodied therein, the computer-readable program code portions which when executed by a processing device are configured to cause the processor to perform the following operations:
identify at least one knowledge graph comprising a plurality of clusters associated with at least one computing system, wherein each cluster of the plurality of clusters comprises a plurality of state machines associated with the at least one computing system;
identify data associated with the at least one computing system;
apply the data associated with the at least one computing system to at least one state machine of the plurality of state machines;
generate, by the at least one state machine, at least one output associated with the at least one computing system;
compare the at least one output with at least one pre-defined output, wherein the at least one pre-defined output is associated with at least one current state attribute of the at least one computing system;
generate a confidence level for the at least one current state attribute based on a level of matching the at least one output to the at least one pre-defined output; and
determine, based on the confidence level meeting a confidence level threshold, a current state attribute for the at least one computing system, wherein the current state attribute defines a current state of the at least one computing system.

12. The computer program product of claim 11, wherein the application of the data is based on a computing component identifier of the at least one state machine.

13. The computer program product of claim 11, wherein the at least one pre-defined output comprises a pre-defined pattern.

14. The computer program product of claim 11, wherein the confidence level is determined based on a likelihood of the at least one output to the at least one pre-defined output match.

15. The computer program product of claim 11, wherein the data associated with the at least one computing system is received by a state machine is based on at least one data subscription.

16. A computer implemented method for determining a computing system's current state by implementing state machines and knowledge graphs, the computer implemented method comprising:
identifying at least one knowledge graph comprising a plurality of clusters associated with at least one computing system, wherein each cluster of the plurality of clusters comprises a plurality of state machines associated with the at least one computing system;
identifying data associated with the at least one computing system;
applying the data associated with the at least one computing system to at least one state machine of the plurality of state machines;
generating, by the at least one state machine, at least one output associated with the at least one computing system;
comparing the at least one output with at least one pre-defined output, wherein the at least one pre-defined output is associated with at least one current state attribute of the at least one computing system;
generating a confidence level for the at least one current state attribute based on a level of matching the at least one output to the at least one pre-defined output; and
determining, based on the confidence level meeting a confidence level threshold, a current state attribute for the at least one computing system, wherein the current state attribute defines a current state of the at least one computing system.

17. The computer implemented method of claim 16, wherein the application of the data is based on a computing component identifier of the at least one state machine.

18. The computer implemented method of claim 16, wherein the at least one pre-defined output comprises a pre-defined pattern.

19. The computer implemented method of claim 16, wherein the confidence level is determined based on a likelihood of the at least one output to the at least one pre-defined output match.

20. The computer implemented method of claim 16, wherein the data associated with the at least one computing system is received by a state machine is based on at least one data subscription.
